(19) United States
(12) Patent Application Publication
(10) Pub. No.: US 2014/0052557 A1
(43) Pub. Date: Feb. 20, 2014

(54) METHOD AND APPARATUS FOR REDEEMING A SOFTWARE SUBSCRIPTION WHILE DETERRING PIRACY

(71) Applicants: Sanjeev Kumar Biswas, Bangalore (IN); Pritom Baruah, Sunnyvale, CA (US); Kiran Kumar, Santa Clara, CA (US); Mayank Goyal, Noida (IN); Suraj Ranjan, Noida (IN); Daniel Carl Brotsky, Berkeley, CA (US)

(72) Inventors: Sanjeev Kumar Biswas, Bangalore (IN); Pritom Baruah, Sunnyvale, CA (US); Kiran Kumar, Santa Clara, CA (US); Mayank Goyal, Noida (IN); Suraj Ranjan, Noida (IN); Daniel Carl Brotsky, Berkeley, CA (US)

(73) Assignee: Adobe Systems Inc., San Jose, CA (US)

(21) Appl. No.: 13/589,490

(22) Filed: Aug. 20, 2012

(51) Int. Cl. G06Q 30/06

(52) U.S. Cl. 705/26.1

(57) ABSTRACT

A method and apparatus for redeeming a software subscription while deterring piracy. The method comprises receiving a request to activate a software subscription, wherein the request comprises a redemption code and a userID; validating the redemption code; retrieving a user profile based on the userID; validating a sales region where the software subscription was purchased against a country code in the user profile; and activating the software subscription upon successful validation of the redemption code and sales region.

### BACKGROUND OF THE INVENTION

1. Field of the Invention

Embodiments of the present invention generally relate to managing the sale of software subscription products and, more particularly, to method and apparatus for redeeming a software subscription while deterring piracy.

2. Description of the Related Art

Software products are becoming available in a low cost subscription format. Purchasing a subscription edition of a software product is like renting the software for a set period of time (term). This means the software only functions for the term of the subscription. During installation, a user logs into the subscription provider's server and enters a subscription serial number in order to use the software. The serial number serves as a key to unlocking access to a specific software subscription product. Once a subscription is activated, the user has access to the software subscription product until the end of the term of the subscription time purchased. A default term is typically a month, however, a user may purchase explicit terms different from the default term, such as a three month term. The subscription provider periodically checks the status of the subscription. For monthly terms, a subscription provider may check the subscription status every 30 days. If a subscription term is found to be expiring at the 30 day status check, the subscription provider charges a user's credit card an agreed upon amount, thereby renewing the subscription for another 30 days or for another term (if a term explicitly requested by the user is different from the default term). However, if the credit card cannot be charged or the subscription was cancelled, access to the software subscription product is terminated.

Subscription software applications may be purchased on-line or in a retail store via a keycard (no disc). The keycard is simply a card containing an activation code for the software subscription. Because access to a software subscription product can be accessed with a simple code, software piracy has become an increasing problem. Unauthorized sellers of “faked” products provide pirated software with counterfeit serial numbers. Consumers who purchase pirated software run the risk of infecting their computer with harmful viruses or other malicious items. In addition, those who purchase pirated software cannot take advantage of benefits, such as software support, guarantees, discounted upgrades and fixes, and maintenance releases.

Another piracy issue involves the sale of “grey market goods, that is, goods acquired, often in bulk, by an unauthorized reseller who purchases genuine software products in geographic areas where the goods have been priced by authorized sellers for sale to retail customers at relatively low prices, and then moves those goods into higher priced geographic areas and resells them at higher prices. The most obvious effect of software piracy is that software development firms and retail stores in the higher priced geographic areas suffer financial losses and some of those losses may be passed onto the consumer in the form of higher prices.

Therefore, there is a need in the art for a method and apparatus for redeeming a software subscription while deterring piracy.

### SUMMARY

Embodiments of the invention generally relate to a method and apparatus for redeeming a software subscription while deterring piracy. The method and apparatus comprise receiving a request to activate a software subscription, wherein the request comprises a redemption code and a userID. The method and apparatus validate the redemption code. The method and apparatus then retrieve a user profile based on the userID and validate a sales region where the software subscription was purchased against a country code in the user profile. The method and apparatus activate the software subscription upon successful validation of the redemption code and sales region.

### BRIEF DESCRIPTION OF THE DRAWINGS

FIG. 1 depicts a block diagram of a system for redeeming a subscription for a software subscription product, according to one or more embodiments;

FIG. 2 depicts a flow diagram of a method for generating a redemption code for a product as performed by the redemption code generator of FIG. 1, according to one or more embodiments;

FIG. 3 depicts a flow diagram for a method for redeeming a redemption code for a product as performed by the serial number redemption module of FIG. 1, according to one or more embodiments;

FIG. 4 depicts a flow diagram for a method for validating a redemption code as performed by the serial number redemption module of FIG. 1, according to one or more embodiments;

FIG. 5 depicts a flow diagram for a method for activating a subscription as performed by the retail subscription manager of FIG. 1, according to one or more embodiments; and

FIG. 6 depicts a computer system that can be utilized in various embodiments of the present invention, according to one or more embodiments.

While the method and apparatus is described herein by way of example for several embodiments and illustrative drawings, those skilled in the art will recognize that method and apparatus for redeeming a software subscription while deterring piracy is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of method and apparatus for redeeming a software subscription while deterring piracy defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention comprise a method and apparatus for redeeming a software subscription while deterring piracy. The embodiments generate a serial number, a vendor identification number (VIN) and a redemption code for a software subscription product. The serial number, VIN, and redemption code, hereafter referred to as a “triple” are associated with one another and define a specific subscription product. Various states (status indicators) are set for each VIN and redemption code, and the triple is stored in a database. Upon purchase of the software subscription product, a user logs into a redemption server (using a userID where the user already has a user profile or by creating a userID and user profile upon a first login to a redemption server) and enters the redemption code provided with the software subscription product. The redemption code is validated to ensure the product associated with the redemption code has in fact been sold and the redemption code has not already been redeemed. A country code associated with a user (determinable via the user's profile) is compared to a sales region with which a sold software subscription product is associated (determinable via the serial number). If the redemption code passes validation and the country code and sales region match, the serial number is used to activate the user's subscription for the software subscription product.

Advantageously, embodiments of the invention provide a seamless user experience as the user does not to enter a serial number in order to activate a subscription product. In addition, the embodiments ensure the status indicators of a product indicate that the product has in fact been sold and the redemption code has not been redeemed thereby making misuse of a subscription product difficult for pirates. Further, embodiments ensure the product was sold in a sales region for which it was intended, thereby denying activation of a subscription that was sold using grey market distribution channels.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

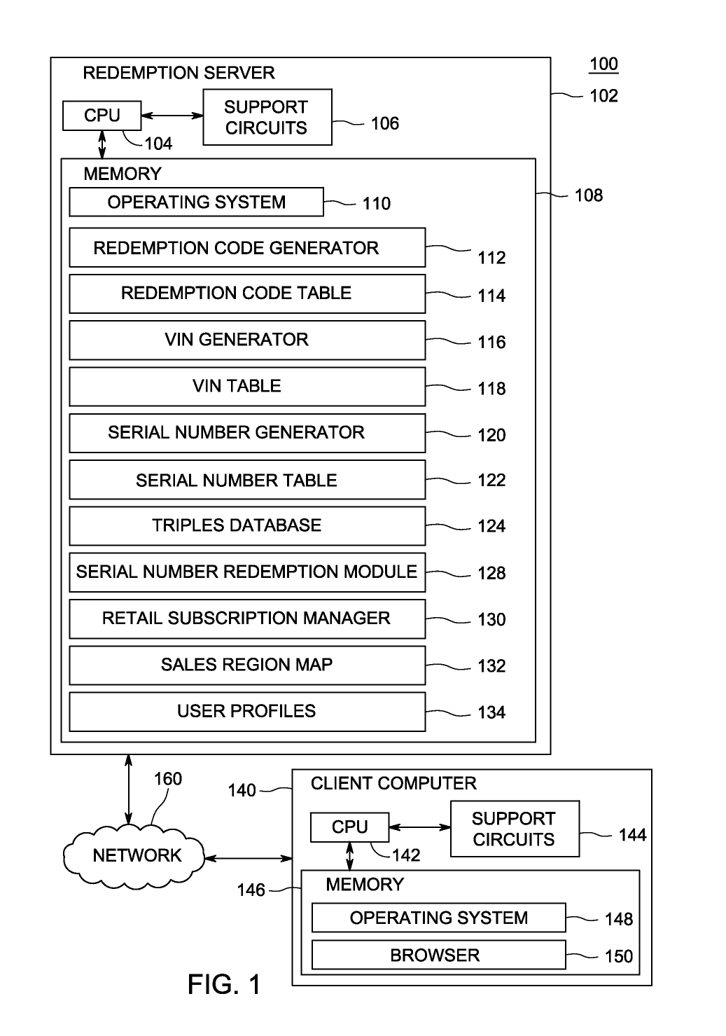

FIG. 1 depicts a block diagram of a system 100 for activating a subscription to a software subscription product, according to one or more embodiments. The system 100 comprises a redemption server 102, and a client computer 140, communicatively coupled to one another over a network 160. The redemption server 102 comprises a Central Processing Unit (CPU) 104, support circuits 106 and a memory 108. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 106 comprises at least one of Read Only Memory (ROM), Random Access Memory (RAM), disk drive storage, optical storage, removable storage and/or the like. The memory 108 comprises an operating system 110, a redemption code generator 112, a redemption code table 114, a vendor identification number (VIN) generator 116, a VIN table 118, a serial number generator 120, a serial number table 122, a triples database 124, a serial number redemption module 128, a retail subscription manager 130, a sales region map 132, and a database of user profiles 134. In some embodiments, the database of user profiles is stored remotely on a remote server (not shown) and the user profiles are retrieved from the remote server by the serial number redemption module 128 when needed.

The operating system (OS) 110 generally manages various computer resources (e.g., network resources, file processors, and/or the like). The operating system 110 is configured to execute operations on one or more hardware and/or software modules, such as Network Interface Cards (NICs), hard disks, virtualization layers, firewalls and/or the like. Examples of the operating system 110 may include, but are not limited to, Linux, Mac OSX, BSD, Unix, Microsoft Windows, and the like. The sales region map 132 is a file containing a mapping between country codes and sales regions. As described in detail further below, in order to activate a subscription, a country code contained in a user profile 134 must match a sales region associated with a sold software subscription product.

The network 160 comprises a communication system that connects computers by wire, cable, fiber optic and/or wireless link facilitated by various types of well-known network elements, such as hubs, switches, routers, and the like. The network 160 may employ various well-known protocols to communicate information amongst the network resources. For example, the network 160 may be a part of the Internet or Intranet using various communications infrastructure, such as Ethernet, Wi-Fi, Wi-Max, General Packet Radio Service (GPRS), and the like.

The client computer 140 comprises a Central Processing Unit (CPU) 142, support circuits 144 and a memory 146. The CPU 142 may comprise one or more commercially available microprocessors or microcontrollers that facilitate data processing and storage. The various support circuits 144 facilitate the operation of the CPU 142 and include one or more clock circuits, power supplies, cache, input/output circuits, and the like. The memory 146 comprises at least one of Read Only Memory (ROM), Random Access Memory (RAM), disk drive storage, optical storage, removable storage and/or the like. The memory 146 comprises an operating system 148, and a browser 150. The operating system (OS) 148 generally manages various computer resources (e.g., network resources, file processors, and/or the like). The operating system 148 is configured to execute operations on one or more hardware and/or software modules, such as Network Interface Cards (NICs), hard disks, virtualization layers, firewalls and/or the like. Examples of the operating system 148 may include, but are not limited to, Linux, Mac OSX, BSD, Unix, Microsoft Windows, and the like. According to some embodiments, the browser 150 is operated by the user to login to the redemption server 102 and enter a redemption code. Examples of a browser 150 may include, but are not limited to, Firefox, Google Chrome, Internet Explorer, Opera, and Safari, Android browser, Firefox for mobile, Internet Explorer Mobile, among others.

Before a user purchases a software subscription product, the product is provisioned on a redemption server 102. Provisioning is a process of preparing and equipping the software subscription product to allow it to provide new or updated services to a user entitled to have access to the product. The redemption code generator 112 accesses stock keeping units (SKUs) for the software subscription product. A software subscription product may have one product SKU with which it is associated, but may be associated with multiple serial SKUs. For example, ADOBE® PHOTOSHOP® has a product SKU, but has different serial SKUs for ADOBE® PHOTOSHOP® English and ADOBE® PHOTOSHOP® German.

The redemption code generator 112 sends a request to the serial number generator 120 to generate a serial number for each serial SKU. The generated serial numbers are stored in the serial number table 122. In one embodiment, the redemption code generator 112 sends a request to the VIN generator 116 to generate VINs for the serial SKUs. In another embodiment, the VINs are generated remotely and provided to the redemption code generator 112. VIN numbers are vendor specific. A VIN identifies the product SKU that is sold by the vendor. The format of the VIN is unique for each vendor. The VINs are stored in the VIN table 118. The redemption code generator 112 then generates a redemption code for each serial SKU and stores each redemption code in the redemption code table 114.

The redemption code generator 112 associates the serial number, VIN, and redemption code and creates “triples” by concatenating the serial number, VIN and redemption codes. The redemption code generator 112 then pairs the VIN with the redemption code from each triple. A VIN/redemption code pair may have one or more serial numbers associated with it. For example, a VIN/redemption code pair for ADOBE® MasterCollection CS6 may be associated with three different serial numbers, one for ADOBE® MasterCollection, a second serial number for ADOBE® After Effects and a third serial number for ADOBE® Color Finesse. In this example, three triples are created with the VIN/redemption code pair. The pairs are stored on key cards. Key cards (rather than software CDs) are provided to a purchaser at the time of sale of a specified software subscription product. In some embodiments, the VIN on the key card may be exposed so it may be scanned when sold by a vendor and the redemption code may be hidden behind an area that must be scratched off in order to access the redemption code.

The VIN and redemption code each have states (status indicators) that are initialized before a product is put on sale. For VINs associated with a vendor of physical retail stores, who has access to the redemption server 102, the VIN is initialized to a state of “UNSOLD”. When a software subscription product is sold by the vendor, the information about the subscription product is sent to the redemption server 102 and the state of the VIN for the software subscription product is changed to “SOLD”. For VINs associated with an online vendor, the VIN is initialized to a state of “SOLD”. The redemption code is initialized to a state of “NOT REDEEMED”. The serial number, VIN, redemption code triples are stored in the triples database 124 and are used when processing a subscription redemption as described below.

After a user purchases a software subscription product, the user logs into the redemption server 102, using a previously stored userID, via the browser 150 on the client computer 140. First time users must first “create an account” to login, which account creation results in user profile data (including a userID) being developed and stored at the redemption server 102. The user sends a request via the browser 150 requesting activation of a subscription for a software subscription product. The software subscription product is typically stored on a cloud server (not shown) and the user is provided access to the software subscription product via the network 160 for the term of the subscription. The user sends the request to activate the purchased subscription. The request is sent to the redemption server 102 by entering the redemption code provided to the user at the time of purchase. The redemption code is typically on a key card. The serial number redemption module 128 receives the request from the client computer 140. The serial number redemption module 128 validates the redemption code by retrieving the triple associated with the redemption code from the triples database 124. The serial number redemption module 128 verifies the state of the VIN is “SOLD” and verifies the state of the redemption code is “NOT REDEEMED”. If the validation is successful, the serial number redemption module 128 validates the sales region where the software subscription product was sold by retrieving the user's profile from the user profiles 134 and matching the country code stored in the user profile 134 to the sales region associated with the SKU of the purchased software subscription product. Valid associations are found in the sales region map 132. If the serial number redemption module 128 matches the country code found in the user profile 134 associated with the user's identification (userID) to the sales region associated with the SKU of the purchased software subscription product, the serial number redemption module 128 updates the state of the redemption code to “REDEEMED” and sends a request to the retail subscription manager 130 to activate the subscription. The retail subscription manager 130 activates the subscription according to the terms of the subscription.

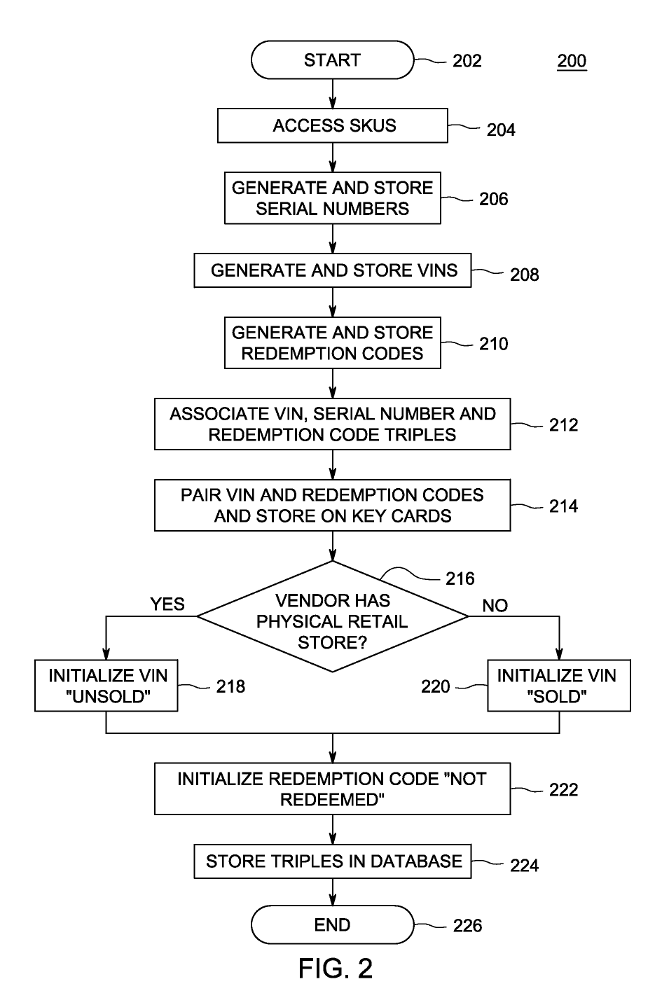

FIG. 2 depicts a flow diagram for a method 200 for generating redemption codes for a software subscription product, as performed by the redemption code generator 112 of FIG. 1, according to one or more embodiments. The method 200 generates a serial number, a vendor identification number (VIN) and a redemption code, associates them with one another for each product, and stores them in a database for future use.

The method 200 starts at step 202 and proceeds to step 204. At step 204, the method 200 accesses stock keeping units (SKUs) for a software subscription product. A software subscription product has one SKU and may have a plurality of serial SKUs. For example, ADOBE® PHOTOSHOP® has a SKU, but has different serial SKUs for ADOBE® PHOTOSHOP® English and ADOBE® PHOTOSHOP® German. The method 200 proceeds to step 206. In some embodiments, at step 206, the method 200 generates a serial number for each serial SKU. In some embodiments, the method 200 sends a request to have the serial numbers generated remotely and receives the generated serial numbers from a remote serial number generator. The method 200 stores the serial numbers in a serial number table.

The method 200 proceeds to step 208. In some embodiments, at step 208, the method 200 generates a VIN for each serial SKU. In some embodiments, the method 200 sends a request to have the VINs generated remotely and receives the generated VINs from a remote VIN generator. The method 200 stores the VINs in a VIN table.

The method 200 proceeds to step 210, where the method 200 generates a redemption code for each serial SKU. The method 200 stores the redemption codes in a redemption code table. The method 200 proceeds to step 212, where the method 200 associates the VIN, serial number, and redemption code. The method 200 creates “triples”, which are the VIN, serial number and redemption code in a predefined order, for example, the triple may be:

<VIN, Redemption Code, Serial Number>.

The method 200 proceeds to step 214, where the method 200 pairs the VIN and the redemption code from each triple. Each pair is stored on a key card, which is provided to a consumer upon purchase of a software subscription product. The method 200 proceeds to step 216, where the method 200 determines if the VIN is associated with a vendor of a physical retail store. A vendor of a physical retail store is able to facilitate updating a state of a VIN to “SOLD” when a software subscription product is purchased. If the method 200 determines the VIN is associated with a vendor of a physical retail store and thus has access to a redemption server of a subscription provider, the method 200 proceeds to step 218, where the method 200 initializes a state of the VIN to “UNSOLD”. The method 200 proceeds to step 222. However, if at step 216, the method 200 determines the vendor associated with the VIN, redemption code pair is associated with an online vendor, the method 200 proceeds to step 220, where the method 200 initializes the state of the VIN to “SOLD”. The method 200 proceeds to step 222.

At step 222, the method 200 initializes a state of the redemption code to “NOT REDEEMED”. The method 200 proceeds to step 224, where the method 200 stores the VIN, redemption code, serial number triples (and their initialized states) in a triples database. The method 200 proceeds to step 226 and ends.

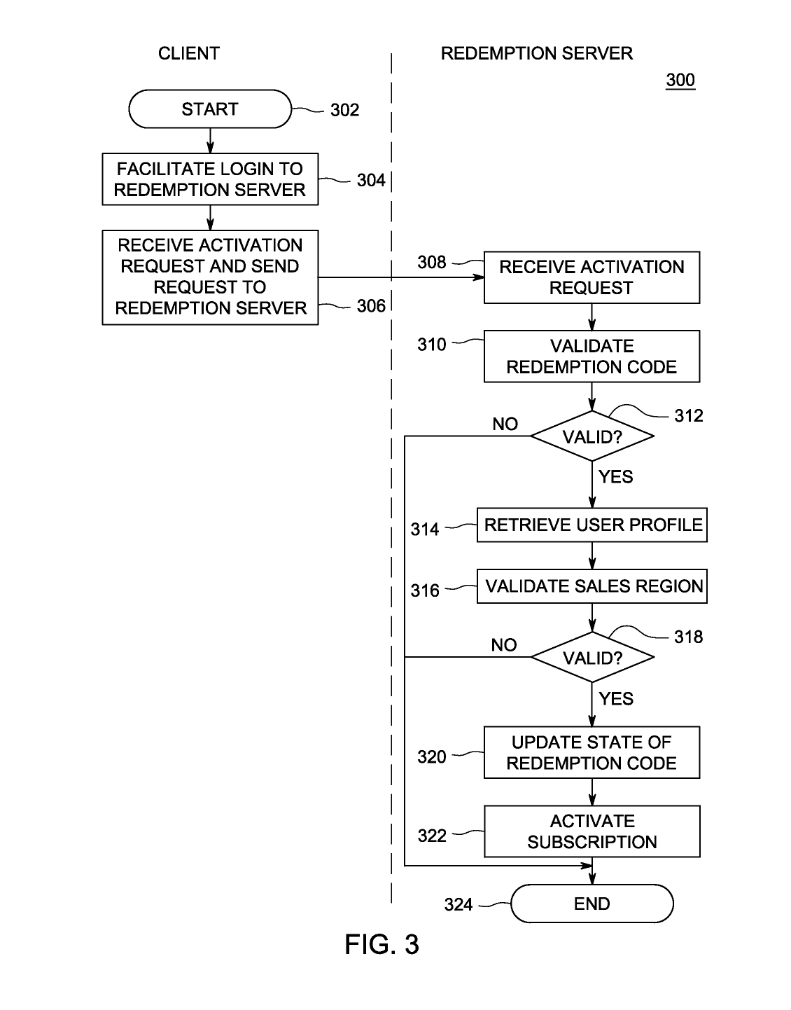

FIG. 3 is a flow diagram of a method 300 for activating a subscription, as performed by the system 100 of FIG. 1. The method 300 receives a redemption code from a user, validates the redemption code, and if the redemption code is valid, activates the user's subscription to the software subscription product.

The method 300 starts at step 302 and proceeds to step 304. At step 304, the method 300 facilitates a user login to a redemption server of a subscription provider. The method 300 proceeds to step 306, where the method 300 receives a request to activate a subscription. The method 300 receives a redemption code and facilitates sending the user login information and the redemption code with the activation request to a redemption server.

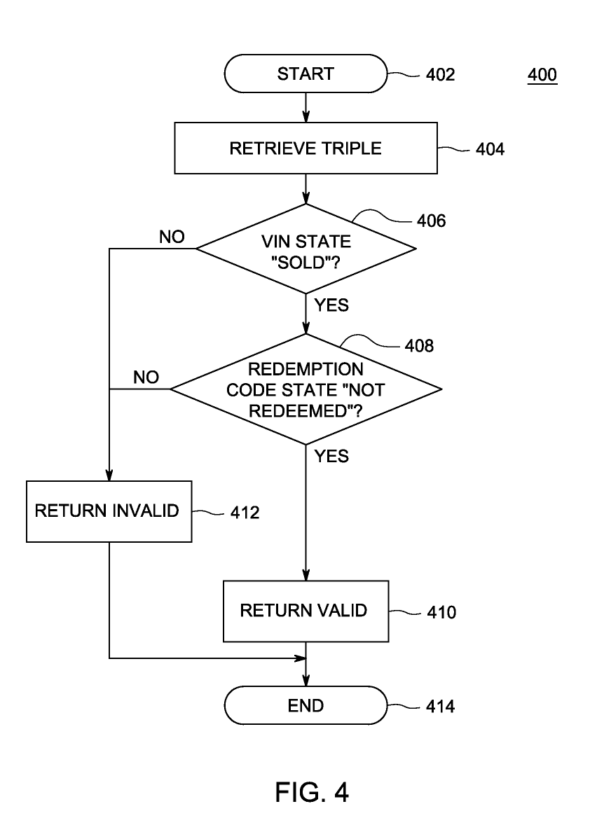

The method 300 proceeds to step 308, where the method 300 receives the activation request on the redemption server. The method 300 proceeds to step 310, where the method 300 validates the redemption code as described in further detail with respect to FIG. 4 below. The method 300 proceeds to step 312, where the method 300 determines a processing path depending upon the validation of the redemption code.

If the method 300 determines the redemption code is invalid, the method 300 proceeds to step 324. If, however, the method 300 determines the redemption code is valid, the method 300 proceeds to step 314, where the method 300 retrieves a user profile. In some embodiments, the method 300 retrieves the user profile associated with the userID from a user profile database. In other embodiments, wherein the user profile database is stored remotely, the method 300 sends a request for a user profile associated with the userID and receives the user profile associated with the userID.

The method 300 proceeds to step 316, where the method 300 validates the sales region where the software subscription product was sold. The method 300 compares a country code found in the user profile to a sales region associated with the sold software product subscription. The method 300 looks up the sales region from the sold software subscription product in a sales region map. If the country code found in the user profile is not mapped to the sales region where the software subscription product was sold, the sales region is invalid. An invalid sales region typically means a software subscription product was purchased in a lower priced geographic region and then resold in a higher priced geographic region by an unauthorized software provider. However, if the country code found in the user profile is mapped to the sales region where the software subscription product was sold, the sales region is valid.

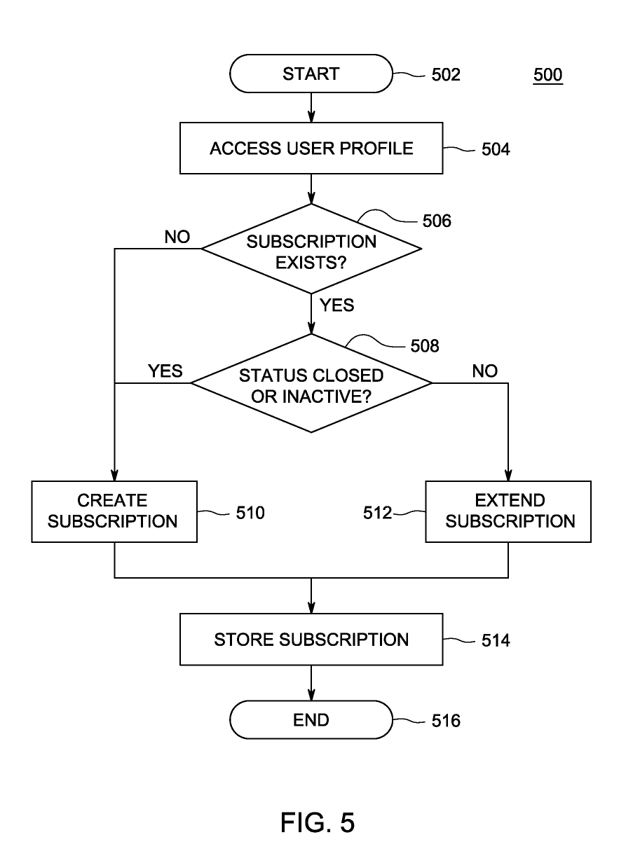

The method 300 proceeds to step 318 and determines whether the sales region was found to be valid. If the sales region was found to be invalid, the method 300 proceeds to step 324 and ends. However, if the method 300 found the sales region to be valid, the method 300 proceeds to step 320, where the method 300 updates the state of the redemption code to “REDEEMED”. The method 300 proceeds to step 322, where the method 300 activates the subscription as described in further detail with respect to FIG. 5 below. The method 300 then proceeds to step 324 and ends.

FIG. 4 is a flow diagram of a method 400 for validating a redemption code as performed by the serial number redemption module 128 of FIG. 1. The method 400 validates that the software subscription product was indeed sold and the redemption code has not yet been redeemed. The method 400 starts at step 402 and proceeds to step 404.

At step 404, the method 400 retrieves the triple containing the redemption code from the triples database. The method 400 proceeds to step 406, where the method 400 evaluates the state of the VIN in the retrieved triple. If the state of the VIN is not “SOLD”, the redemption code was misappropriated and the method 400 proceeds to step 412. However, if the state of the VIN is “SOLD”, the method 400 proceeds to step 408. At step 408, the method 400 evaluates the state of the redemption code in the retrieved triple. If the state of the redemption code is “REDEEMED”, the redemption code has already been used to activate a subscription and the method 400 proceeds to step 412.

However, if the state of the redemption code is “NOT REDEEMED”, the method 400 proceeds to step 410. After the VIN and redemption code are verified, the redemption code is considered to be valid. At step 410, the method 400 returns that the redemption code is VALID. The method 400 proceeds to step 414 and ends. If the state of the VIN was not determined to be “SOLD” or the redemption code was not determined to be “NOT REDEEMED”, the method 400 proceeded to step 412, where the method 400 returns that the redemption code is INVALID. The method 400 then proceeds to step 414 and ends.

FIG. 5 is a flow diagram for a method 500 for activating a subscription as performed by the retail subscription manager 130 of FIG. 1, according to one or more embodiments of the invention. The method 500 determines the type of subscription a user currently possesses and the terms of the subscription the user has purchased and activates the subscription accordingly.

The method 500 starts at step 502 and proceeds to step 504. At step 504, the method 500 accesses the user profile retrieved for the user. The user profile contains information regarding subscriptions currently held by the user (if any) and the status and terms of those subscriptions. The method 500 proceeds to step 506 where the method 500 determines whether a subscription for the purchased software subscription product already exists in the user profile. If the method 500 determines that a subscription does not exist in the user profile, the method 500 proceeds to step 510, where the method 500 creates a new subscription for the user. The new subscription includes information regarding the subscription identification information and terms, and may include explicit terms in the event the user purchased a subscription for a term other than a default term, for example if the user purchased a subscription with a three month term rather than a monthly term. The new subscription may be:

{“ident”:“103419112915446026569831”,“serviceCode”:“cs_dse_{—2}
”,“serviceStatus”:“ACTIVE”,“serviceLevel”:“CS_LVL_1”,“ownerGuid”:
“012A3C184F14027D0A490D25”,“ownerAuthSrc”:“WCD”,
“delegateGuid”:“012A3C184F14027D0A490D25”,“delegateAuthSrc”:
“WCD”,“subRef”:“1034-1911-2915-4460-2656-9831”,“createDts”:
1326715584000,“modDts”:1326715584000,“effectiveEndDts”:
1329319799000,“params”:[{“pn”:“dtsm_lf_ttl_start”,
“pv”:“432000”},{“pn”:“dtsm_lf_ttl_grace”,
“pv”:“432000”},{“pn”:“DSP_PRODUCT_VERSION”,
“pv”:“1.0”},{“pn”:“DSP_SCENARIO_KEY”,
“pv”:“12345566”}]},

The method 500 proceeds to step 514.

If at step 506, the method 500 determines a subscription exists in the user profile for the software subscription product, the method 500 proceeds to step 508, where the method 500 determines the current status of the subscription. Different states exist for a subscription, for example, “ACTIVE”, “STOPPED” (meaning the user cancelled the subscription), “SUSPENDED” (for example, if a user's credit card cannot be charged), “SUSPENDED30” (meaning the subscription has been suspended for more than 30 days), “CLOSED” (meaning the subscription has been shut down by the subscription provider), or “INACTIVE” (meaning a subscription has been “CLOSED” for more than thirty days). It is appreciated that although six potential subscription types are included, other embodiments of the present disclosure envision addition possible subscription types.

If the current status, as shown in the example above in the “serviceStatus” field of the purchased software subscription product is “CLOSED” or “INACTIVE”, the method 500 proceeds to step 510, where the method 500 creates a new subscription for the user and the method 500 proceeds to step 514. Closed and inactive subscriptions cannot be extended and a new subscription must be created. However, if the current status of the purchased software subscription product is not “CLOSED” and is not “INACTIVE”, the method 500 extends the current subscription for the user updating at least the status and terms of the purchased subscription. The method 500 proceeds to step 514. At step 514, the method 500 stores the updated subscription in the user profile. The method proceeds to step 516 and ends.

The embodiments of the present invention may be embodied as methods, system, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

### Example Computer System

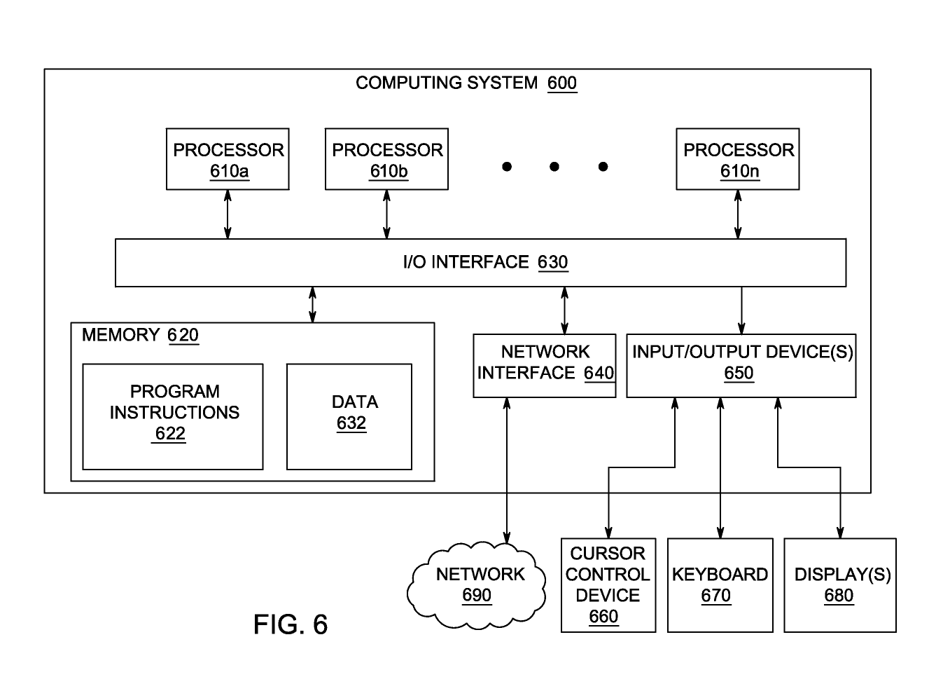

FIG. 6 depicts a computer system that is a computing device and can be utilized in various embodiments of the present invention, according to one or more embodiments.

Various embodiments of a method and apparatus for redeeming a software subscription while deterring piracy, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 200, 300, 400, and 500 as processor-executable executable program instructions 622 (e.g., program instructions executable by processor(s) 610a-n) in various embodiments.

In the illustrated embodiment, computer system 600 includes one or more processors 610a-n coupled to a system memory 620 via an input/output (I/O) interface 630. The computer system 600 further includes a network interface 640 coupled to I/O interface 630, and one or more input/output devices 650, such as cursor control device 660, keyboard 670, and display(s) 680. In various embodiments, any of components may be utilized by the system to receive user input described above. In various embodiments, a user interface (e.g., user interface) may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610a-n may be any suitable processor capable of executing instructions. For example, in various embodiments processors 610 may be general-purpose or embedded processors implementing any of a variety of instruction set architectures (ISAs), such as the x96, PowerPC, SPARC, or MIPS ISAs, or any other suitable ISA. In multiprocessor systems, each of processors 610a-n may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one components (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated by the flowcharts of FIGS. 2 through 5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
receiving a request to activate a software subscription, wherein the request comprises a redemption code and a userID;
validating the redemption code;
retrieving a user profile based on the userID;
validating a sales region where the software subscription was purchased against a country code in the user profile; and
activating the software subscription upon successful validation of the redemption code and sales region.

2. The method of claim 1, wherein validating the redemption code comprises:
retrieving a triple associated with the software subscription, wherein the triple comprises the redemption code, a serial number and a vendor identification number(VIN), wherein the serial number and VIN are associated with the redemption code.

3. The method of claim 2, wherein validating the redemption code further comprises verifying the software subscription was sold.

4. The method of claim 3, wherein validating the redemption code further comprises verifying the software subscription was not redeemed.

5. The method of claim 1, wherein validating the sales region comprises verifying a country code in the user profile is associated with a sales region in which the software subscription was sold.

6. The method of claim 1, wherein activating the subscription comprises creating an entry in the user profile comprising information regarding the software subscription terms.

7. The method of claim 1, wherein activating the subscription comprises extending a subscription, wherein extending comprises updating status and subscription terms in the user profile.

8. An apparatus for redeeming a software subscription comprising:
a redemption code generator for creating a plurality of triples, wherein each triple in the plurality of triples comprises a redemption code, vendor identification number (VIN) and a serial number, wherein each triple in the plurality of triples is associate with a software subscription product;
a serial number redemption module for receiving a request to activate a software subscription, wherein the request comprises a redemption code and a userID, for validating the redemption code, retrieving a user profile based on the userID, and validating a sales region where the software subscription was purchased in a country code in the user profile; and
a retail subscription manager for activating the software subscription upon successful validation of the redemption code and the sales region.

9. The apparatus of claim 8, wherein the serial number redemption module validates the redemption code by:
retrieving a triple associated with the software subscription, wherein the serial number and VIN are associated with the redemption code.

10. The apparatus of claim 9, wherein the serial number redemption module further validates the redemption code by verifying the software subscription was sold and verifying the software subscription was not redeemed.

11. The apparatus of claim 8, wherein the serial number redemption module validates the sales region by verifying a country code in the user profile is associated with a sales region in which the software subscription was sold.

12. The apparatus of claim 8, wherein the retail subscription manager activates the subscription by creating an entry in the user profile comprising information regarding the software subscription terms.

13. The apparatus of claim 8, wherein activating the subscription comprises extending a subscription, wherein extending comprises updating status and subscription terms in the user profile.

14. A non-transient computer readable medium for storing computer instructions that, when executed by at least one processor cause the at least one processor to perform a method of redeeming a software subscription comprising:
receiving a request to activate a software subscription, wherein the request comprises a redemption code and a userID;
validating the redemption code;
retrieving a user profile based on the userID;
validating a sales region where the software subscription was purchased against a country code in the user profile; and
activating the software subscription upon successful validating of a sales region.

15. The computer readable medium of claim 14, wherein validating the redemption code comprises:
retrieving a triple associated with the software subscription, wherein the triple comprises the redemption code, a serial number and a vendor identification number(VIN), wherein the serial number and VIN are associated with the redemption code.

16. The computer readable medium of claim 15, wherein validating the redemption code further comprises verifying the software subscription was sold.

17. The computer readable medium of claim 16, wherein validating the redemption code further comprises verifying the software subscription was not redeemed.

18. The computer readable medium of claim 14, wherein validating the sales region comprises verifying a country code in the user profile is associate with a sales region in which the software subscription was sold.

19. The computer readable medium of claim 14, wherein activating the subscription comprises creating an entry in the user profile comprising information regarding the software subscription terms.

20. The computer readable medium of claim 14, wherein activating the subscription comprises extending a subscription, wherein extending comprises updating status and subscription terms in the user profile.
